(19) United States
(12) Patent Application Publication
(10) Pub. No.: US 2022/0225401 A1
(43) Pub. Date: Jul. 14, 2022

(54) METHODS FOR PRECONFIGURED DOWNLINK COMMUNICATION, NETWORK NODES AND WIRELESS DEVICES

(71) Applicant: Sony Group Corporation, Tokyo (JP)

(72) Inventors: Rickard LJUNG, Helsingborg (SE); Nafiseh MAZLOUM, Lund (SE); Basuki PRIYANTO, Lund (SE); Anders BERGGREN, Lund (SE)

(21) Appl. No.: 17/613,051

(22) PCT Filed: May 15, 2020
(86) PCT No.: PCT/EP2020/063725

§ 371 Date: Nov. 20, 2021

(30) Foreign Application Priority Data
Jun. 17, 2019 (SE) 1950732-6

(51) Int. Cl. H04W 72/14

(52) U.S. Cl. CPC H04W 72/14

(57) ABSTRACT

The present disclosure provides a method performed by a network node, for preconfigured downlink transmission to a wireless device. The wireless device is in idle mode. The method comprises receiving signalling on a preconfigured uplink resource, PUR, from the wireless device. The method comprises transmitting, to the wireless device, in response to the signalling received on the PUR, a downlink response for PUR signalling, wherein the downlink response is indicative of a preconfigured downlink resource, PDR, grant. The method comprises transmitting to the wireless device preconfigured downlink data on the pre-configured downlink resource, PDR, associated with the PDR grant.

The present disclosure pertains to the field of wireless communications. The present disclosure relates to methods for preconfigured downlink transmission, methods for preconfigured downlink reception, network nodes and wireless devices.

### BACKGROUND

The 3rd Generation Partnership Project (3GPP) works on specifying a method for preconfigured uplink resources (PUR) for the scenario where a wireless device (e.g. a user equipment) has the possibility to transmit data using preconfigured uplink resources. The wireless device can ask a network node for such allocation, and the network node can configure the allocation of PUR via Radio Resource Control (RRC) signaling. For example, the wireless device can transmit a small payload using the PUR. For example, the wireless device can repeatedly transmit uplink data transmissions in a known time interval corresponding to PUR.

However, the downlink communication is not optimally supported in the present scenario.

### SUMMARY

One potential use case where downlink communication may be needed is for example when a wireless device is connected to a cloud server which is expected to provide status information to the wireless device with a given repeated pattern (e.g. every hour or similar).

According to legacy 3GPP standard, this illustrative data traffic pattern can already be supported but not optimally. Indeed, in order to receive the data traffic, the wireless device is required to perform substantive amount of signaling (cf. FIG. 1B) to be able to receive the downlink data. The legacy functionality creates signaling overhead and consumes energy which does not appear to be advantageous when considering the relatively limited amount of data that may be received by the wireless device.

Accordingly, there is a need for methods, network nodes, wireless devices which mitigate, alleviate or address the shortcomings existing in the 3GPP standard and provides a pre-configuration of the downlink communication in connection with PUR, e.g. pre-configured downlink resources for a wireless device in idle mode, which allows the wireless device to receive downlink data in a time-efficient and resource-efficient manner.

The present disclosure provides a method performed by a network node, for preconfigured downlink transmission to a wireless device. The wireless device is in idle mode. The method comprises receiving signalling on a preconfigured uplink resource, PUR, from the wireless device. The method comprises transmitting, to the wireless device, in response to the signalling received on the PUR, a downlink response for PUR signalling. The downlink response is indicative of a preconfigured downlink resource, PDR, grant. The method comprises transmitting to the wireless device preconfigured downlink data on the preconfigured downlink resource, PDR, associated with the PDR grant.

A network node is provided, the network node comprising: a memory circuitry, a processor circuitry, and a wireless interface. The network node is configured to perform any of the methods disclosed herein.

The network node disclosed herein can schedule an earlier downlink data transmission to a wireless device in idle mode (e.g. RRC_IDLE, RRC_INACTIVE, RRC_SUSPENDED), based on signalling received in PUR which may indicate that there is downlink data to be expected for the wireless device.

The present disclosure furthermore provides a method, performed by a wireless device, for preconfigured downlink reception from a network node. The wireless device is in idle mode. The method comprises transmitting, to the network node, signalling on a preconfigured uplink resource, PUR, from the wireless device. The method comprises receiving, from the network node, a downlink response for PUR signalling. The downlink response is indicative of a preconfigured downlink resource, PDR, grant.

Further, a wireless device is provided, the wireless device comprising: a memory circuitry, a processor circuitry, and a wireless interface. The wireless device is configured to perform any of the methods disclosed herein.

The wireless device can obtain an earlier scheduling of the downlink data, and thereby can receive the downlink data without random access procedure or RRC connection establishment even if the wireless device is in idle mode. This is further beneficial when the wireless device is to receive smaller downlink data receptions for which it may not be advantageous to perform legacy procedures illustrated in FIG. 1B (because the signalling overhead of the legacy procedures is larger than the downlink data to be received). For example, smaller downlink data receptions may include for example a response to an alarm (gas leakage) reported by PUR and thus, the response is a small data indicating to “stop” the operation or to “shutdown”. For example, smaller downlink data receptions may be a downlink data transmission that can be carried out in one transport block which has the size e.g. less than 1000 bits. Furthermore, smaller downlink data can be arranged in a transmission with multiple transport blocks.

It may be appreciated that the disclosed method allows for power efficiency and resource efficiency at the wireless device compared to legacy procedures.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an exemplary wireless communication system comprising an exemplary network node and an exemplary wireless device according to this disclosure,

FIG. 1B is a signalling diagram illustrating legacy procedures between an exemplary network node and an exemplary wireless device according to 3GPP standard,

FIG. 1C is a signalling diagram illustrating an exemplary signalling between an exemplary network node and an exemplary wireless device according to the present disclosure,

FIG. 2 is a flow-chart illustrating an exemplary method, performed in an exemplary network node, for preconfigured downlink transmission to an exemplary wireless device according to this disclosure,

FIG. 3 is a flow-chart illustrating an exemplary method, performed in an exemplary wireless device, for preconfigured downlink reception from an exemplary network node according to this disclosure,

FIG. 4 is a block diagram illustrating an exemplary network node according to this disclosure,

FIG. 5 is a block diagram illustrating an exemplary wireless device according to this disclosure, and

FIGS. 6A-C are signalling diagrams illustrating exemplary signalling diagrams between an exemplary network node and an exemplary wireless device according to the present disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

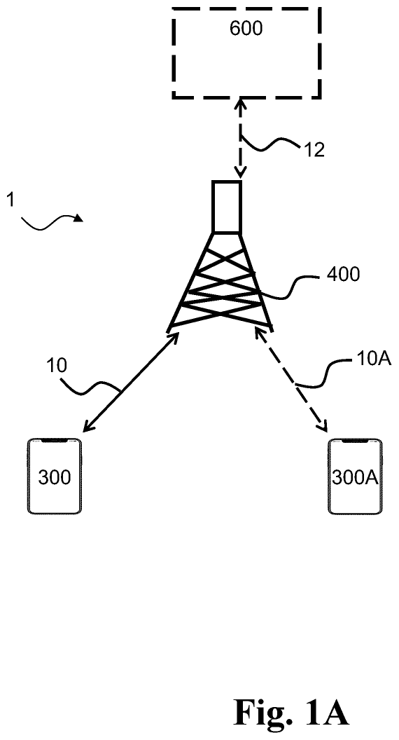

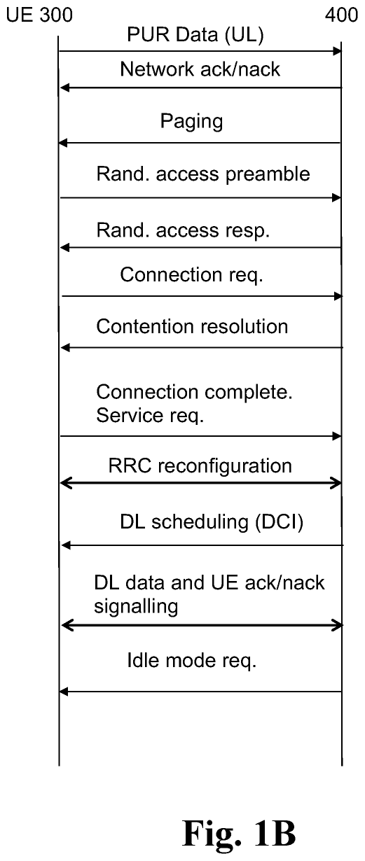

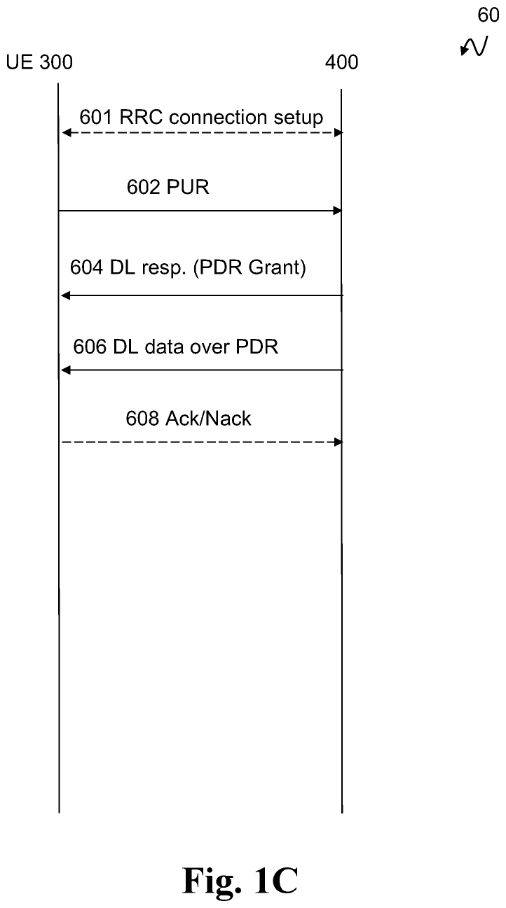

FIG. 1A shows a diagram illustrating an exemplary wireless communication system 1 comprising an exemplary network node 400 and an exemplary wireless device 300 according to this disclosure.

As discussed in detail herein, the present disclosure relates to a wireless communication system 1 comprising a cellular system, e.g. a 3GPP wireless communication system. The wireless communication system 1 comprises a wireless device 300 and/or a network node 400.

A network node disclosed herein refers to a radio access network node operating in the radio access network, such as a base station, an evolved Node B, eNB, gNB. The wireless communication system 1 described herein may comprise one or more wireless devices 300, 300A, and/or one or more network nodes 400, such as one or more of: a base station, an eNB, a gNB and/or an access point.

A wireless device may refer to as a mobile device and/or a user equipment, UE.

The wireless device 300, 300A may be configured to communicate with the network node 400 via a wireless link (or radio access link) 10, 10A.

The wireless device 300, 300A may be configured to communicate data with an external device 600 (e.g. a server device, e.g. a cloud-based server device) via the network node 400. The external device 600 may be configured to communicate with the network node 400 over communication link 12.

FIG. 1B shows a signalling diagram illustrating legacy procedures between an exemplary network node 400 and an exemplary wireless device UE 300 according to 3GPP standard.

The wireless device 300 communicates with the network node 400 PUR data, which the network node acknowledges with network ACK/NACK.

An example use case where downlink communication may be needed is for example when a wireless device is connected to a cloud server where the cloud server is expected to provide status information to the wireless device with a given repeated pattern (e.g. every hour or similar). The cloud server may be a computer connected to the Internet.

According to legacy 3GPP standard, in order to receive such data traffic, the wireless device is required to perform substantive amount of signaling illustrated FIG. 1B to be able to receive the downlink data. Furthermore, there may be a substantial delay between the PUR transmission and the paging occasion in which this can be a disadvantage for non-delay tolerant application. For example, a substantial delay may be in the order of 10's of minutes.

To receive the data, the wireless device 300 is configured with suitable idle mode DRX configuration. When the network node 400 has received downlink data from e.g. application server, the network node 400 transmits paging to the wireless device 300. The wireless device 300 accordingly responds to the paging with contention based random access and RRC connection setup procedure where a random access preamble is initially transmitted by the wireless device 300 according to the allocated random access resources. The network node 400 responds to the preamble with a random access response message to the wireless device 300.

The wireless device 300 continues with an RRC connection setup message, and after the RRC connection setup complete message has been received, the RRC connection may be reconfigured. The network node 400 sends downlink scheduling information including a Downlink Control Information (DCI) message to the wireless device 300. Finally, the downlink data can be communicated to the wireless device 300.

Once the downlink data transmission is complete, the network node 400 may request the wireless device 300 to be in idle mode.

As illustrated in FIG. 1B, the legacy procedures create signaling overhead and consumes energy which does not appear to be advantageous when considering the relatively limited amount of data that may be received by the wireless device 300.

The wireless device disclosed herein can benefit from receiving data periodically on preconfigured downlink resources without the need for paging and contention-based random access. The downlink transmission may be preconfigured by the network node by pre-configuring one or more of: a modulation and coding scheme (MCS), a periodicity of transmission, a frequency, a bandwidth, a time of transmission, and a number of repetitions. For example, an example scenario where the wireless device uses PUR for uplink transmissions and may benefit from the disclosed preconfigured downlink resources is for internet of things communication. In such an example scenario, the wireless device may repeatedly transmit uplink data transmissions in a known time interval corresponding to PUR and downlink communication may be needed when a wireless device is connected to a cloud server which is expected to provide status information to the wireless device with a given repeated pattern (e.g. every hour or similar).

Other alternatives for providing the wireless device with the downlink data according to legacy functionalities may be performed without idle mode DRX. In such case the legacy method may include transmitting the data when the wireless device is in RRC connected mode based on that the wireless device has initiated the procedure to transition to the RRC connected state. However, the wireless device may anyway benefit from receiving data on preconfigured downlink resources without the need to initiate the initial access procedure or to transition to RRC connected state.

The present disclosure uses the transmission opportunity of a preconfigured uplink resource (PUR) to signal a need for further allocation of downlink resources for upcoming downlink data transmissions. The allocation of the downlink transmission resource for upcoming downlink data transmissions are denoted Preconfigured Downlink Resource (PDR). The downlink transmission is preconfigured in that one or more of the following parameters may be preconfigured on a downlink resource: a modulation and coding scheme (MCS), a periodicity of transmission, a frequency of transmission, a bandwidth, a time of transmission, and a number of repetitions.

A preconfigured uplink resource comprises a pre-allocated uplink resource in one or more embodiments of the present disclosure.

In other words, the present disclosure proposes a functionality for resource allocations to perform “small” downlink data transmissions while the wireless device remains in some sort of an idle state, e.g. RRC Idle or RRC Inactive, and where the UE may be suspended from RRC connected mode. This may be seen as configuring a set of resources for an upcoming downlink data transfer and receiving the data according to the configuration while the downlink data can be received without prior random access procedure or RRC connection setup/establishment. For example, a “small” downlink data reception may be a downlink data transmission that can be carried out in one transport block which has the size e.g. less than 1000 bits.

FIG. 1C shows a signalling diagram 60 illustrating an exemplary signalling between an exemplary network node 400 and an exemplary wireless device 300 according to the present disclosure. The signalling diagram 60 illustrates that the wireless device 300 is capable of requesting pre-allocation of downlink resources while transmitting uplink according to preconfigured uplink resources.

The downlink resources may have been preconfigured during RRC connection set up 601 between the wireless device 300 and the network node 400.

The wireless device, UE 300, transmits over the PUR, PUR signalling 602 (optionally including uplink data) to the network node 400.

The PUR signalling 602 may comprise a PDR request.

The network node 400 responds by transmitting to the wireless device 300 a downlink response 604 as part of the PUR signalling. For example, the downlink response 604 is indicative of a PDR grant. Optionally, the downlink response 604 may comprise the PDR grant. The downlink response 604 may be part of an acknowledgment of the PUR signalling.

The wireless device 300 may monitor a downlink channel (e.g. a downlink shared channel, and/or a downlink control channel).

The network node 400 transmits to the wireless device 300 preconfigured downlink data 606 on the preconfigured downlink resource, PDR, associated with the PDR grant.

The wireless device 300 may respond with an acknowledgment message 608 to the network node 400.

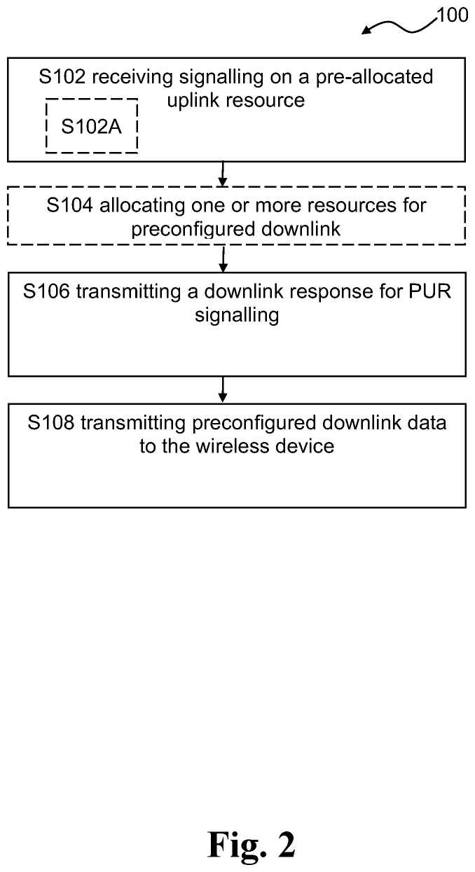

FIG. 2 shows a flow diagram of an exemplary method 100 performed by a network node (e.g. the network node disclosed herein, e.g. network node 400 of FIGS. 1A, 1B, 4, and 6A-C) according to the disclosure. The method 100 is performed for preconfigured downlink transmission to a wireless device, wherein the wireless device (e.g. the wireless device disclosed herein, e.g. wireless device 300 of FIGS. 1A, 5, and 6A) is in idle mode. Idle mode may refer to a dormant state, (such as RRC_IDLE, RRC_INACTIVE, RRC_SUSPENDED state).

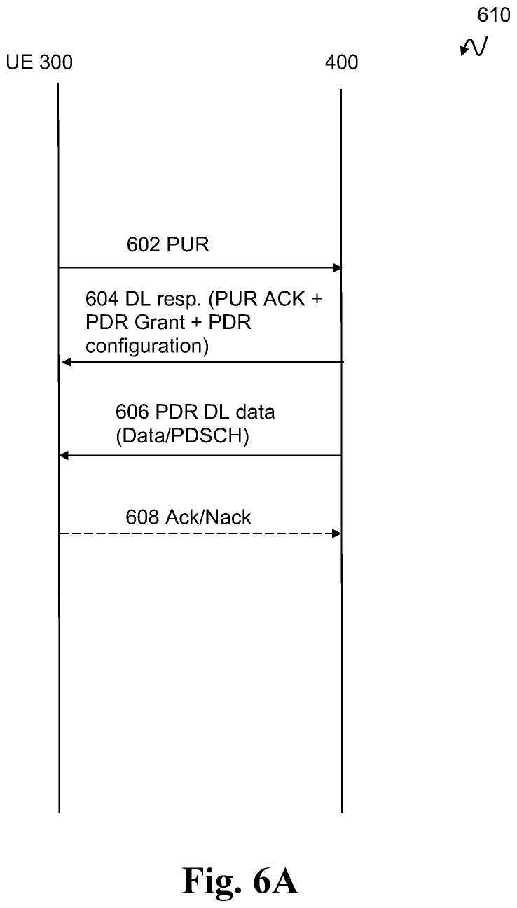

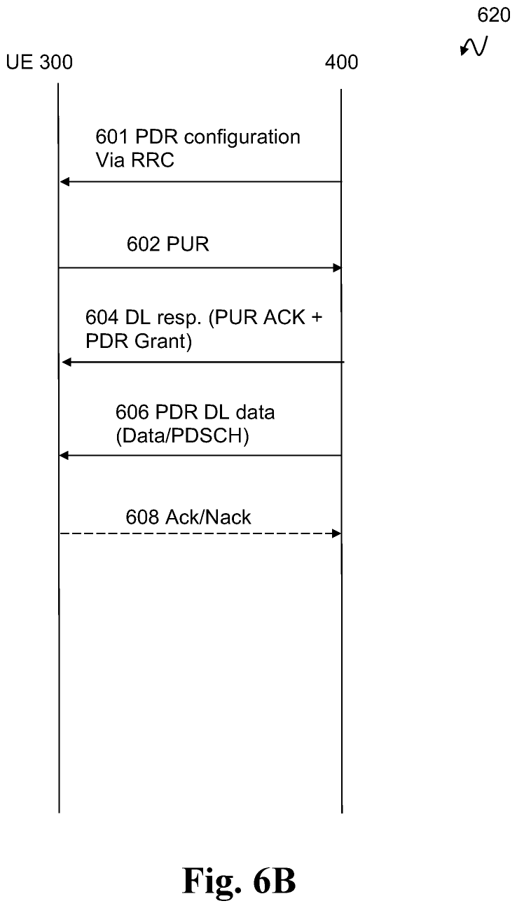

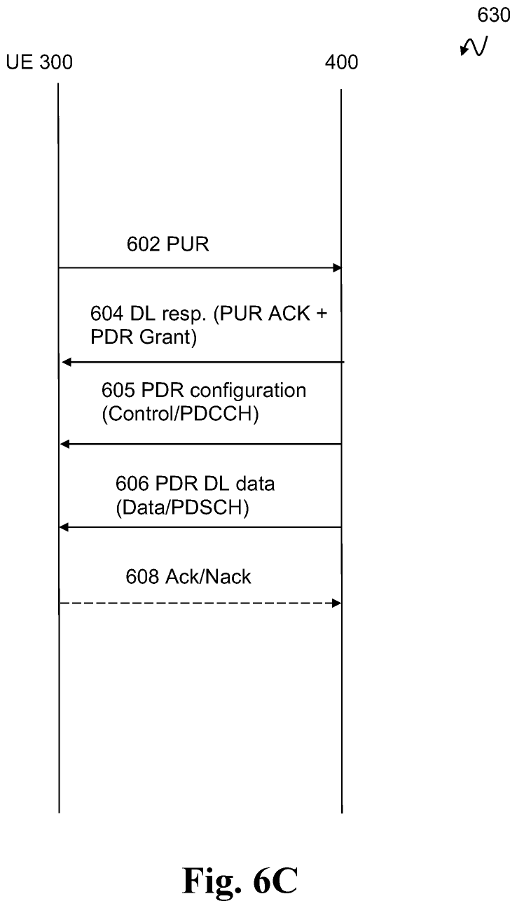

The downlink transmission may be preconfigured by the network node by pre-configuring one or more of: a modulation and coding scheme (MCS), a periodicity of transmission, a frequency, a time of transmission, and a number of repetitions. For example, in one or more embodiments, the downlink transmission may be preconfigured by the network node in RRC signaling, particularly when the wireless device is initially connected and receive configuration from the network node (cf. FIG. 6B). Alternatively, the downlink transmission may be preconfigured by the network node over PUR signaling (cf. FIG. 6A, 6C).

The method 100 comprises receiving S102 signalling on a preconfigured uplink resource, PUR, from the wireless device. In one or more example methods, signalling on a preconfigured uplink resource, PUR, may comprise reconfiguration of PUR. Receiving S102 signalling on PUR from the wireless device may comprise receiving uplink data on the PUR from the wireless device.

The method 100 comprises transmitting S106, to the wireless device, a downlink response for PUR signalling. The downlink response may be transmitted to the wireless device in response to the signalling received on the PUR in S102. In other words, the downlink response is seen as forming part of the PUR signalling. In one or more example methods, the downlink response for PUR signalling is included in an acknowledgment of the received signalling on the PUR from the wireless device.

A preconfigured uplink resource may comprise a pre-allocated uplink resource.

The downlink response is indicative of a PDR grant. For example, the downlink response is indicative of a preconfigured downlink resource, PDR, grant for the upcoming downlink data to be received on the preconfigured downlink resource. For example, the downlink response comprises a PDR grant in response to the PUR signalling. In other words, the PDR grant is included in the downlink response, which is sent to acknowledge the PUR.

It may be appreciated that the downlink resource disclosed herein may be preconfigured (e.g. with a preconfigured MCS, periodicity, frequency etc.) in an initial phase (e.g. during RRC setup), and the PDR grant may be an indication that the preconfigured downlink resource may be used.

In one or more example methods, the PDR grant comprises allocation information. The allocation information may be in form of a flag and/or a DCI adapted to PDR.

The method 100 comprises transmitting S108, to the wireless device, preconfigured downlink data on the preconfigured downlink resource, PDR, associated with the PDR grant. Transmitting S108 may be seen as optional in the broadest embodiment as the network node is not mandated to transmit downlink data over the preconfigured downlink resource but has the possibility to transmit the downlink data over the preconfigured downlink resource (for example, when the data is received from the external device, e.g. server device). Transmitting S108 to the wireless device the preconfigured downlink data is performed using the pre-configuration associated with the PDR (e.g. a downlink configuration parameter disclosed herein, such as a preconfigured MCS).

In one or more example methods, the PDR grant is indicative of one or more PD occasions. Transmitting S108, to the wireless device, preconfigured downlink data on the preconfigured downlink resource, PDR, associated with the PDR grant may comprise transmitting, to the wireless device, preconfigured downlink data on a preconfigured downlink occasion associated with the PDR grant (corresponding to the PDR). In an example embodiment, the wireless device may be configured to monitor the control channel for the PDR grant (e.g. a physical downlink control channel (PDCCH), or a PDCCH for machine type communications (MPDCCH)). In an example embodiment, at the PDR occasions, the wireless device may not be configured to monitor the control channel. In an example embodiment, at the PDR occasions, the wireless device may not be configured to monitor a shared channel, such as a shared downlink channel (e.g. a physical downlink shared channel (PDCCH)).

In one or more example embodiments, the PUR configuration is associated with the PDR configuration, and the method comprises reusing the PUR confirmation for PDR configuration.

In other words, the PDR grant is included in the downlink response, which may be sent to acknowledge the PUR transmission.

In one or more embodiments, a PDR grant may be transmitted as a physical layer signalling (e.g. control signalling on the physical layer). This may for example be transmitted on a shared control channel on the physical layer.

Alternatively, in one or more embodiments, a PDR grant may be transmitted as part of an RRC control signalling message, and thereby be coupled with signalling in layers above the physical layer.

The disclosed method advantageously allows application data to be received (earlier than legacy procedures) by the wireless device while the wireless device is in an otherwise idle mode, such as in dormant state (such as RRC idle or RRC suspended or RRC inactive state). As the wireless device has already been configured with one or more uplink resources (e.g. PUR) to be used within idle mode, the disclosed method allows the wireless device to include in the PUR communication an indication of the need/wish to be configured with a PDR. Further, as a PUR transmission is followed with a network transmission of acknowledgement of the PUR transmission (e.g. an ACK/NACK indicator, where the network node indicates to the UE whether the uplink transmission was successful or not), the disclosed network nodes can provide a grant response for the PDR communication within the network response to the PUR.

In one or more example methods, the PDR grant can be a single occasion, or multiple occasions within a given repetition pattern (based on e.g. PDR timing).

In one or more example methods, the network node may be configured to transmit a PDR grant without a UE initiated PDR request. For example, it is the network node that initiates the PDR transmission, e.g. based on network awareness of typical data pattern or similar. For example, the network node may initiate the PDR based on UE or network initiated early data transmission (EDT) for transmissions of “small” data, and where the network node during the RACH procedure decide to configure PDR, for small data which is not possible to fit into the EDT procedure.

In one or more example methods, the method 100 comprises allocating S104 one or more resources for preconfigured downlink, PD, transmission to the wireless device. The downlink response may comprise allocation information (e.g. downlink control information (DCI) adapted for preconfigured DL resources).

In one or more example methods, receiving S102 signalling on a preconfigured uplink resource, PUR, from the wireless device comprises receiving S102A, from the wireless device, control signalling indicative of a PDR request. For example, the wireless device may transmit the PDR request on a PUR transmission to the network node. In one or more example methods, the PDR request is indicative of timing parameter of the preconfigured downlink, PD, occasions, a frequency parameter of the PD occasions, a bandwidth parameter of the PD occasions, and a data size parameter for the PD occasions. For example, the PDR request can indicate timing information (such as PDR timing, such as number of frames after the PUR) and optionally can include a data size parameter indicative of a data size expectation. For example, the wireless device can expect to receive the downlink data according to the PDR timing or using timing information indicated by the network node in an acknowledgement of a PDR request. For example, at the PDR occasion, the wireless device may be expected to monitor the shared channel and optionally the control channel (e.g. the Physical Downlink Control Channel, PDCCH). For example, in the control channel, the wireless device can identify information on the PDR to carry the downlink data, for example: a data size parameter (e.g. Transport Block Size (TBS), one or more downlink configuration parameters (e.g. MCS, and/or resource information, and/or activation of PDR with semi-persistent configuration.

In one or more example methods, the downlink response for PUR signalling is included in an acknowledgment of the received signalling on the PUR from the wireless device and/or an acknowledgement of the PDR request (e.g. PDR ACK message of the PDR request transmitted in a PUR). For example, an acknowledgement of the PDR request may comprise a physical layer acknowledgement (such as L1 acknowledgement). For example, the PDR ACK message may be in the form of a simple ack/nack flag of the UE PDR request. For example, the PDR ACK message may include specific allocation information (e.g. downlink control information (DCI) adapted for preconfigured DL resources). This information may support the wireless device in not monitoring control channels such as for example PDCCH prior to or during the upcoming PDR transmission. The wireless device may monitor the shared channel (e.g. PDCCH).

In one or more example methods, the downlink response indicative of the PDR grant is indicative of a downlink configuration parameter. In one or more example methods, the downlink configuration parameter may comprise one or more of: time and/or frequency resources, a modulation and coding scheme (MCS), repetitions number, Transport block size (TBS), periodicity, and a hopping pattern. It is to be noted that in one or more embodiments, the downlink configuration parameter may be conveyed to the wireless device in RRC signaling, particularly when the wireless device is initially connected and receive configuration from the network node.

In one or more example methods, the downlink configuration parameter may be indicative of a configuration setting, which is part of a set of predetermined configuration settings comprising e.g. timing, amount of data etc. For example, once the wireless device requests a PDR (e.g. in PUR signaling, e.g. with a PDR request), the wireless device can select one of the configured predetermined configuration settings for PDR. For example, the network node may negotiate the configuration setting with the wireless device by e.g. indicating in the PDR ACK message a selected configuration setting, e.g. to overrule the configuration setting requested from the wireless device.

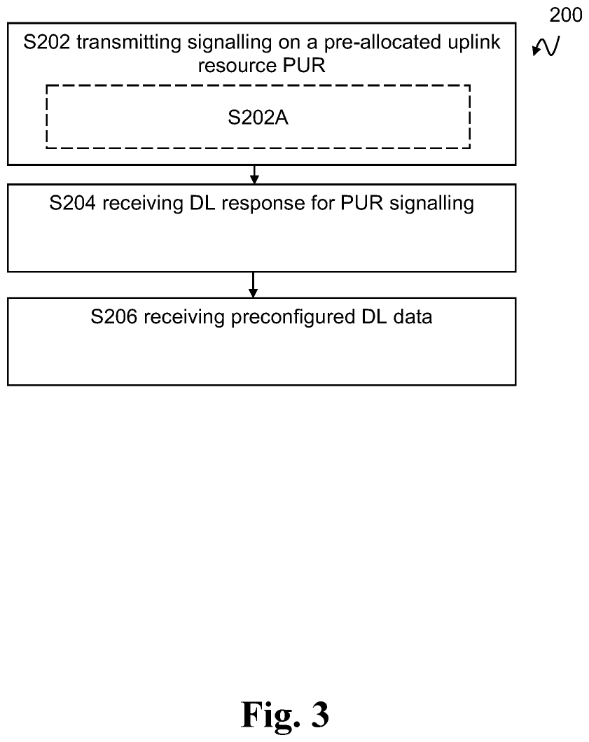

FIG. 3 shows a flow diagram of an exemplary method 200 performed by a wireless device according to the disclosure (such as the wireless device disclosed herein, such as the wireless device performing the method of FIG. 2, such as wireless device 300 of FIGS. 1A, 1B, 4, and 6A-C). The method 200 is performed for preconfigured downlink reception from a network node. The wireless device is configured for communication over preconfigured uplink resources, and may be expecting downlink data from an external device, e.g. a cloud server. The wireless device is configured to indicate the upcoming downlink data to the network node so that the preconfigured downlink resource method can be used at the wireless device.

The wireless device is in idle mode, e.g. a dormant state (such as RRC_IDLE, RRC_INACTIVE, RRC_SUSPENDED state). For example, the network node may have triggered the wireless device to enter the idle mode, with e.g. a long discontinuous reception, DRX. This may be illustrated by the example scenario of the wireless device acting as an internet-of-things device which transmits regularly uplink data using PUR and can benefit from status information from a cloud server. Accordingly, the wireless device may need to receive downlink data on preconfigured downlink resources without having to perform the legacy signaling of FIG. 1B.

The downlink transmission may be preconfigured at the wireless device, by the network node which pre-configures one or more of: a modulation and coding scheme (MCS), a periodicity of transmission, a frequency, a time of transmission, and a number of repetitions. For example, in one or more embodiments, the downlink transmission may be preconfigured by the network node in RRC signaling, particularly when the wireless device is initially connected and receive configuration from the network node. Alternatively, the downlink transmission may be preconfigured by the network node over PUR signaling.

The method 200 comprises transmitting S202, to the network node, signalling on a preconfigured uplink resource, PUR, from the wireless device. In one or more example methods, signalling on a preconfigured uplink resource, PUR, may comprise reconfiguration of PUR. Transmitting 202 signalling on PUR to the network node may comprise transmitting uplink data on the PUR to the network node. In one or more example methods, transmitting S202, to the network node, signalling on a preconfigured uplink resource, PUR, comprises transmitting 5202A, to the network node, control signalling indicative of a preconfigured downlink resource, PDR, request. The control signalling is received by the network node in step S102 of FIG. 2.

The method 200 comprises receiving S204, from the network node, a downlink response for PUR signalling. The downlink response may be transmitted to the wireless device in response to the signalling received by the network node on the PUR (see Step S106 of FIG. 2). Stated differently, PUR signalling may comprise a downlink response for PUR signalling, which is received from the network node in response to the signalling received on PUR. The downlink response is indicative of a preconfigured downlink resource, PDR, grant. For example, the downlink response may comprise the PDR grant. In other words, the PDR grant is included in the downlink response, which is sent to acknowledge the PUR. In one or more example methods, the downlink response for PUR signalling is received by the wireless device in an acknowledgment of the received signalling on the PUR transmitted by the wireless device. In other words, the network node transmits the downlink response in response to the PUR signalling received from the wireless device which may indicate the need for a PDR grant.

In one or more example methods, the method 200 comprises receiving S206, from an external node via the network node, preconfigured downlink data according to the PDR grant. In other words, for example, a server device as the external node sends data for the wireless device via the network node. For example, the data may be buffered by the network node for transmission to the wireless device as preconfigured downlink data over PDR. The network node may transmit the preconfigured downlink data to the wireless device as described in S108 of FIG. 2.

It may be appreciated that the wireless device can benefit from a reception of the downlink data using the disclosed method which is earlier than using the legacy procedures.

In one or more example methods, the PDR grant is indicative of one or more PD occasions. Receiving S206, from the network node, preconfigured downlink data on the preconfigured downlink resource, PDR, associated with the PDR grant may comprise receiving, from the network node, preconfigured downlink data on a preconfigured downlink occasion associated with the PDR grant (corresponding to the PDR). At the PDR occasions, the wireless device may be configured to monitor a shared channel. the wireless device may be configured to monitor the control channel for the PDR grant. In one or more example methods, the PDR grant can be a single occasion, or multiple occasions within a given repetition pattern (based on e.g. PDR timing).

In one or more example methods, the PDR request is indicative of one or more of: a timing parameter of the PD occasions, a frequency parameter of the PD occasions, a bandwidth parameter of the PD occasions, a data size parameter for the PD occasion. For example, the PDR request can indicate timing information (such as PDR timing, such as number of frames after the PUR) and optionally can include a data size parameter indicative of a data size expectation. For example, the wireless device can expect to receive the downlink data according to the PDR timing or using timing information indicated by the network node in an acknowledgement of a PDR request. For example, at the PDR occasion, the wireless device may be expected to monitor a shared channel and/or the control channel (e.g. the Physical Downlink Control Channel, PDCCH). For example, in the control channel, the wireless device can identify information on the PDR to carry the downlink data, for example: a data size parameter (e.g. Transport Block Size (TBS), one or more downlink configuration parameters (e.g. MCS, and/or resource information, and/or activation of PDR with semi-persistent configuration.

In one or more example methods, the downlink response indicative of the preconfigured downlink resource, PDR, grant is included in an acknowledgment of the received signalling on the PUR from the wireless device and/or an acknowledgement of the PDR request. For example, an acknowledgement of the PDR request may comprise a physical layer acknowledgement (such as L1 acknowledgement). For example, the PDR ACK message may be in the form of a simple ack/nack flag of the UE PDR request. For example, the PDR ACK message may include specific allocation information (e.g. downlink control information (DCI) adapted for preconfigured DL resources).

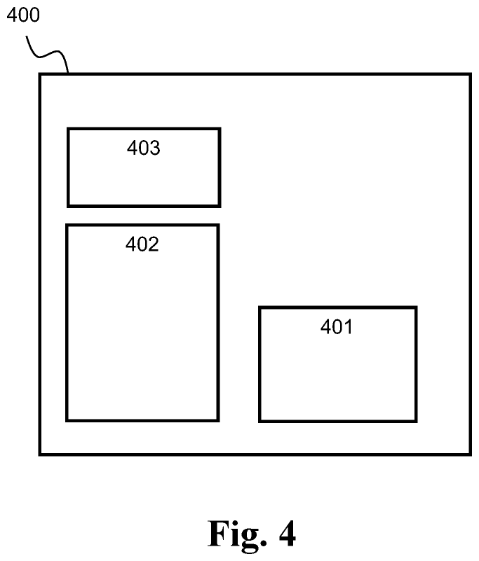

FIG. 4 shows a block diagram of an exemplary network node 400 according to the disclosure. The network node comprises a memory circuitry 401, a processor circuitry 402, and a wireless interface 403. The network node 400 is configured to perform any of the methods disclosed in FIG. 2.

The network node 400 is configured to communicate with a wireless device, such as the wireless device 300 disclosed herein, using a wireless communication system (as illustrated in FIG. 1A). The wireless interface 403 is configured for wireless communications via a wireless communication system, such as a 3GPP system, such as a 3GPP system supporting PUR signalling.

The network node 400 is configured to receive (for example via the wireless interface 403) signalling on a preconfigured uplink resource, PUR, from the wireless device.

The network node 400 is configured to transmit (for example using the wireless interface 403), to the wireless device, a downlink response for PUR signalling (e.g. and in response to the signalling received on the PUR). The downlink response is indicative of a preconfigured downlink resource, PDR, grant

The network node 400 is configured to transmit (for example using the wireless interface 403), to the wireless device, preconfigured downlink data on the preconfigured downlink resource, PDR, associated with the PDR grant.

The processor circuitry 402 is optionally configured to perform any of the operations disclosed in FIG. 2 (for example S102A, S104). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the wireless circuitry is configured to carry out. Also, while the described functions and operations may be implemented in software, such functionality may as well be carried out via dedicated hardware or firmware, or some combination of hardware, firmware and/or software.

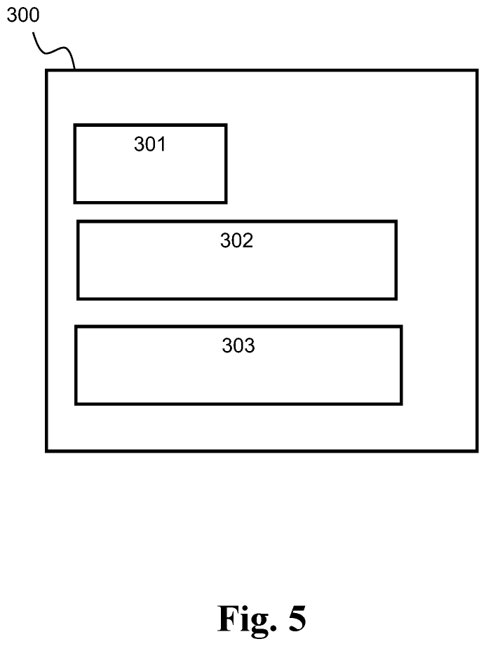

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 5). The memory circuitry 401 is considered a non-transitory computer readable medium.

The memory circuitry 401 may be configured to store a set of predetermined configuration settings in a part of the memory circuitry 401.

FIG. 5 shows a block diagram of an exemplary wireless device 300 according to the disclosure. The wireless device 300 comprises a memory circuitry 301, a processor circuitry 302, and a wireless interface 303. The wireless device 300 may be configured to perform any of the methods disclosed in FIG. 3.

The wireless device 300 is configured to communicate with a network node, such as the network node disclosed herein, using a wireless communication system. The wireless interface 303 is configured for wireless communications via a wireless communication system, such as a 3GPP system, such as a 3GPP system supporting PUR.

The wireless device 300 is configured to transmit (e.g. via the wireless interface 303), to the network node, signalling on a preconfigured uplink resource, PUR, from the wireless device.

The wireless device 300 is configured to receive (e.g. via the wireless interface 303), from the network node, a downlink response for PUR signalling. The downlink response is indicative of a preconfigured downlink resource, PDR, grant

The processor circuitry 302 is optionally configured to perform any of the operations disclosed in FIG. 3 (for example S202A). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless device 300 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 303. The memory circuitry 301 may exchange data with the processor circuitry 302 over a data bus. Control lines and an address bus between the memory circuitry 301 and the processor circuitry 302 also may be present (not shown in FIG. 5). The memory circuitry 301 is considered a non-transitory computer readable medium.

The memory circuitry 301 may be configured to store a set of predetermined configuration settings.

FIG. 6A shows a signalling diagram 610 illustrating an exemplary signalling between an exemplary network node 400 and an exemplary wireless device 300 according to the present disclosure. The signalling diagram 610 illustrates that the wireless device 300 is capable of requesting pre-allocation of downlink (DL) resources while transmitting uplink according to preconfigured uplink resources.

The wireless device, UE 300, transmits over the PUR, PUR signalling 602 (optionally including uplink data) to the network node 400. The PUR signalling 602 may comprise a PDR request.

The network node 400 responds by transmitting to the wireless device 300 a downlink response 604 as part of the PUR signalling. For example, the downlink response 604 is indicative of a PDR grant by comprising a PDR grant. In this example, the downlink response comprises a PDR configuration, such as one or more downlink configuration parameters for the preconfigured downlink resource. The wireless device 300 uses the PDR configuration to properly receive the preconfigured downlink data at the PDR occasions. The downlink response 604 may be part of an acknowledgment of the PUR signalling.

The wireless device 300 may monitor the shared channel, e.g. PDSCH for receiving the preconfigured DL data.

The network node 400 transmits to the wireless device 300 preconfigured downlink data 606 on the preconfigured downlink resource, PDR, associated with the PDR grant over the downlink shared channel, PDSCH.

The wireless device 300 may respond with an acknowledgment message 608 to the network node 400.

FIG. 6B shows a signalling diagram 620 illustrating an exemplary signalling between an exemplary network node 400 and an exemplary wireless device 300 according to the present disclosure. The signalling diagram 620 illustrates that the wireless device 300 is capable of requesting pre-allocation of downlink resources while transmitting uplink according to preconfigured uplink resources.

The wireless device, UE 300, receives from the network node 400 a PDR configuration, such as one or more downlink configuration parameters for preconfigured downlink resource(s) via RRC signaling. This may take place during RRC connection setup.

The wireless device, UE 300, transmits over the PUR, PUR signalling 602 (optionally including uplink data) to the network node 400. The PUR signalling 602 may comprise a PDR request.

The network node 400 responds by transmitting to the wireless device 300 a downlink response 604 as part of the PUR signalling. For example, the downlink response 604 is indicative of a PDR grant by comprising a PDR grant. The downlink response 604 includes an acknowledgment of the PUR signalling.

The wireless device 300 may monitor the shared channel, e.g. PDSCH for receiving the preconfigured DL data.

The network node 400 transmits to the wireless device 300 preconfigured downlink data 606 on the preconfigured downlink resource, PDR, associated with the PDR grant over the downlink shared channel, PDSCH.

The wireless device 300 may respond with an acknowledgment message 608 to the network node 400.

FIG. 6C shows a signalling diagram 630 illustrating an exemplary signalling between an exemplary network node 400 and an exemplary wireless device 300 according to the present disclosure. The signalling diagram 630 illustrates that the wireless device 300 is capable of requesting pre-allocation of downlink resources while transmitting uplink according to preconfigured uplink resources.

The wireless device, UE 300, transmits over the PUR, PUR signalling 602 (optionally including uplink data) to the network node 400. The PUR signalling 602 may comprise a PDR request.

The network node 400 responds by transmitting to the wireless device 300 a downlink response 604 as part of the PUR signalling. For example, the downlink response 604 is indicative of a PDR grant by comprising a PDR grant. The PDR grant may comprise an indication of time and/or frequency where the wireless device is to monitor the PDR occasion. In this example, the downlink response 604 comprises an acknowledgment of the PUR signalling.

The network node 400 transmits, over a control channel, such as PDCCH, to the wireless device 300 a PDR configuration 605 (e.g. PDR PDSCH configuration), such as one or more downlink configuration parameters for the preconfigured downlink resource. The wireless device 300 uses the PDR configuration to properly receive the preconfigured downlink data at the PDR occasions.

The wireless device 300 may monitor the shared channel, e.g. PDSCH for receiving the preconfigured DL data.

The network node 400 transmits to the wireless device 300 preconfigured downlink data 606 on the preconfigured downlink resource, PDR, associated with the PDR grant over the downlink shared channel, PDSCH.

The wireless device 300 may respond with an acknowledgment message 608 to the network node 400.

Embodiments of methods and products (network node and wireless device) according to the disclosure are set out in the following items:

Item 1. A method, performed by a network node, for preconfigured downlink transmission to a wireless device, wherein the wireless device is in idle mode, the method comprising:
receiving (S102) signalling on a preconfigured uplink resource, PUR, from the wireless device;
transmitting (S106), to the wireless device, a downlink response for PUR signalling and in response to the signalling received on the PUR, wherein the downlink response is indicative of a preconfigured downlink resource, PDR, grant; and
transmitting (S108), to the wireless device, preconfigured downlink data on the preconfigured downlink resource, PDR, associated with the PDR grant.
   Item 2. The method according to item 1, the method comprises: allocating (S104) one or more resources for preconfigured downlink, PD, transmission to the wireless device.
   Item 3. The method according to any of items 1-2, wherein receiving (S102) signalling on a preconfigured uplink resource, PUR, from the wireless device comprises receiving (S102A), from the wireless device, control signalling indicative of a PDR request.
   Item 4. The method according to any of the previous items, wherein the PDR grant is indicative of one or more PD occasions.
   Item 5. The method according to any of items 3-4, wherein the PDR request is indicative of one or more of: a timing parameter of the preconfigured downlink, PD, occasions, a frequency parameter of the PD occasions, a bandwidth parameter of the PD occasions, and a data size parameter for the PD occasions.
   Item 6. The method according to any of items 3-5, wherein the downlink response indicative of the PDR grant is included in an acknowledgment of the received signalling on the PUR from the wireless device and/or an acknowledgement of the PDR request.
   Item 7. The method according to any of items 3-5, wherein the downlink response indicative of the PDR grant is indicative of a downlink configuration parameter.
   Item 8. A method, performed by a wireless device, for preconfigured downlink reception from a network node, wherein the wireless device is in idle mode, the method comprising:
transmitting (S202), to the network node, signalling on a preconfigured uplink resource, PUR, from the wireless device; and
receiving (S204), from the network node, a downlink response for PUR signalling, wherein the downlink response is indicative of a preconfigured downlink resource, PDR, grant.
   Item 9. The method according to item 8, the method comprising receiving, from an external node via the network node, preconfigured downlink data according to the PDR grant.
   Item 10. The method according to any of items 8-9, wherein transmitting (S202), to the network node, signalling on a preconfigured uplink resource, PUR, comprises transmitting (5202A), to the network node, control signalling indicative of a preconfigured downlink resource, PDR, request.
   Item 11. The method according to item 10, wherein the PDR request is indicative of one or more of: a timing parameter of the PD occasions, a frequency parameter of the PD occasions, a bandwidth parameter of the PD occasions, and a data size parameter for the PD occasions.
   Item 12. The method according to any of items 8-11, wherein the downlink response indicative of the preconfigured downlink resource, PDR, grant is included in an acknowledgment of the received signalling on the PUR from the wireless device and/or an acknowledgement of the PDR request.
   Item 13. A network node comprising a memory circuitry, a processor circuitry, and a wireless interface, wherein the network node is configured to perform any of the methods according to any of items 1-7.
   Item 14. A wireless device comprising a memory circuitry, a processor circuitry, and a wireless interface, wherein the wireless device is configured to perform any of the methods according to any of items 8-12.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-6C comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a network node, for preconfigured downlink transmission to a wireless device, wherein the wireless device is in idle mode, the method comprising:
receiving signalling on a preconfigured uplink resource (PUR) from the wireless device;
transmitting to the wireless device, in response to the signaling received on the PUR, a downlink response for PUR signalling, wherein the downlink response is indicative of a preconfigured downlink resource (PDR) grant; and
transmitting, to the wireless device, preconfigured downlink data on the preconfigured downlink resource (PDR) associated with the PDR grant.

2. The method according to claim 1, the method comprises: allocating one or more resources for preconfigured downlink (PD) transmission to the wireless device.

3. The method according to claim 1, wherein receiving-signalling on a preconfigured uplink resource (PUR) from the wireless device comprises receiving, from the wireless device, control signalling indicative of a PDR request.

4. The method according to claim 1, wherein the PDR grant is indicative of one or more PD occasions.

5. The method according to claim 3, wherein the PDR request is indicative of one or more of: a timing parameter of the preconfigured downlink (PD) occasions, a frequency parameter of the PD occasions, a bandwidth parameter of the PD occasions, and a data size parameter for the PD occasions.

6. The method according to claim 3, wherein the downlink response indicative of the PDR grant is included in an acknowledgment of the received signaling on the PUR from the wireless device and/or an acknowledgement of the PDR request.

7. The method according to claim 3, wherein the downlink response indicative of the PDR grant is indicative of a downlink configuration parameter.

8. A method, performed by a wireless device, for preconfigured downlink reception from a network node, wherein the wireless device is in idle mode, the method comprising:
transmitting, to the network node, signalling on a preconfigured uplink resource (PUR); and
receiving, from the network node, a downlink response for PUR signalling, wherein the downlink response is indicative of a preconfigured downlink resource (PDR) grant.

9. The method according to claim 8, the method comprising receiving, from an external node via the network node, preconfigured downlink data according to the PDR grant.

10. The method according to claim 8, wherein transmitting, to the network node, signalling on a preconfigured uplink resource (PUR) comprises transmitting, to the network node, control signalling indicative of a preconfigured downlink resource (PDR) request.

11. The method according to claim 10, wherein the PDR request is indicative of one or more of: a timing parameter of the PD occasions, a frequency parameter of the PD occasions, a bandwidth parameter of the PD occasions, and a data size parameter for the PD occasions.

12. The method according to claim 8, wherein the downlink response indicative of the preconfigured downlink resource, (PDR) grant is included in an acknowledgment of the received signalling on the PUR from the wireless device and/or an acknowledgement of the PDR request.

13. A network node comprising a memory circuitry, a processor circuitry, and a wireless interface, wherein the network node is configured to perform any of the methods according to claim 1.

14. A wireless device comprising a memory circuitry, a processor circuitry, and a wireless interface, wherein the wireless device is configured to perform any of the methods according to claim 8.
